(19) United States
(12) Patent Application Publication
(10) Pub. No.: US 2007/0143807 A1
(43) Pub. Date: Jun. 21, 2007

(54) DATA DISTRIBUTION APPARATUS, DATA PROVISION APPARATUS AND DATA DISTRIBUTION SYSTEM COMPRISED THEREOF

(75) Inventor: Toru Suneya, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/610,410

(22) Filed: Dec. 13, 2006

(30) Foreign Application Priority Data
Dec. 19, 2005 (JP) 2005-365423

(51) Int. Cl. H04N 7/173; H04N 7/16

(52) U.S. Cl. 725/115; 725/86; 725/87; 725/91; 725/92; 725/145

(57) ABSTRACT

For example, when ISO Base Media File Format Fragmented Movie media data is transmitted in a data transfer protocol such as HTTP or the like, the same data is provided from a network camera 100. Then, at an intermediate server 101, the header information is changed according to the destined playback device 102 and data for distribution to each individual playback device 102 is generated, achieving media data distribution using a data transfer protocol while reducing data traffic as well as the data processing load on the distribution source.

### BACKGROUND OF THE INVENTION

1. Field of the Invention

The present invention relates to a technology for transmitting and receiving multimedia data over a comparatively wide area, and more particularly, to multicast-like data distribution using a protocol suitable for file transfer.

2. Description of the Related Art

Recently, so-called surveillance cameras for the purpose of monitoring for anti-theft purposes or checking conditions at remote locations are becoming widespread. RTP (A Transfer Protocol for Real-Time Applications) has come to be widely used as the protocol used when distributing in real time video and audio captured by an image capture device such as a surveillance camera. RTP has been standardized by the IETF (Internet Engineering Task Force) as RFC1889 and RFC1890, and is a protocol for the transfer of audio data and video data in real time.

However, in live video distribution using RTP, sometimes distribution cannot be carried out if a firewall is set up in front of the destined client. In addition, since RTP is a protocol that places a premium on real time delivery, dropouts of data packets that contain the live video and audio may occur. Consequently, live video distribution using simpler protocols such as HTTP (HyperText Transfer Protocol) is being studied.

Conventionally, as a file recording format suitable for such real-time processing, there is Fragmented Movie in ISO Base Media File Format.

In Fragmented Movie, data pertaining to the whole moving picture data and metadata corresponding to divided moving picture data (moving picture data divided according to a predetermined reference standard) are described at the head of a file, after which the divided moving picture data corresponding to the metadata is recorded. Then, as in the same manner, the metadata of the divided moving picture data and the corresponding divided moving picture data are recorded sequentially in chronological order. It should be noted that a constant length of time period is often used as the reference standard for dividing the moving picture data.

Thus, as described above, in Fragmented Movie, the combination of one divided moving picture data and its metadata can be treated as one lump. Recording in such a format enables captured moving picture data to be fragmented according to certain conditions and recorded on demand. As a result, implementing live video distribution by sequentially transferring fragmented moving picture data (that is, divided moving picture data) and transmitting the data as files is being studied.

In addition, with protocols suitable for file transfer such as HTTP, it is necessary to inform the receiving end in advance of the data size that is to be transferred. As a result, configurations that can accommodate such requirement are also being considered.

In live video distribution, the overall size of the data to be transmitted cannot be determined in advance of data transmission. However, by transmitting at each divided moving picture data it is possible to notify the receiving end of the size of the divided moving picture data when transmitting data, enabling protocols such as HTTP that require advance notice of the data size to be utilized.

Alternatively, achieving the same configuration by sending a transmission request size from the receiving end to the transmitting end and transmitting from the transmitting end divided moving picture data of the requested size has also been proposed (see Japanese Patent Application Laid-Open No. 2005-27010). This arrangement involves receiving gradually by using a Range function defined by HTTP to maintain the connection status as is and sequentially acquire portions of data from the receiving end.

By the way, when providing the same video distribution to multiple parties using RTP, a distribution scheme called multicast is commonly used. Multicast is a technique for transmitting a single packet to a specified number of recipients, in which a packet designated for multicast is duplicated by an appropriate intermediate router and transmitted to each receiving terminal. The advantage of this scheme is that, since there is no need to duplicate the data at the transmission source, data traffic and the data processing load on the transmission source can be reduced.

On the other hand, video distribution utilizing Fragmented Movie as described above and carried out using HTTP or the like is used when transmitting to clients behind firewalls or in applications in which data packet dropouts are particularly unwelcome. However, this scheme is basically a block transfer of moving picture files, and in the case of live video distribution in particular, a portion of the metadata inserted in the video data changes depending on the timing of the start of reception of the moving picture data. As a result, this scheme differs from video distribution by multicast, which distributes the same data to all recipients.

### SUMMARY OF THE INVENTION

The present invention has as its object to solve the problems described above. The present invention achieves media data transmission using a data transfer protocol while reducing data traffic and the data processing load on the distribution source.

According to an aspect of the present invention, there is provided a data distribution apparatus for distributing media data including at least one of audio data and video data to a communicably connected receiving terminal device, comprising: a managing unit that manages receiving terminal device information that is information relating to the receiving terminal device; a receiving unit that receives media data divided into predetermined units and first and second additional information corresponding to such media data; a generating unit that generates distribution data for each destined receiving terminal device from one of the first and second additional information and the divided media data based on the receiving terminal device information corresponding to the destined receiving terminal device; and a transmitting unit that transmits the distribution data to a corresponding receiving terminal device, wherein the generating unit changes the second additional information based on the receiving terminal device information corresponding to the destined receiving terminal device and generates the distribution data from such changed second additional information and from corresponding the media data.

According to another aspect of the present invention, there is provided a data provision apparatus that converts media data including at least one of audio data and video data into data for distribution to a receiving terminal device and outputting the data for distribution, comprising: an acquisition unit that acquires the media data; a dividing unit that divides the media data into predetermined units; a storage unit that stores information relating to the receiving terminal device; an additional information generating unit that generates first and second additional information corresponding to the divided media data; and a transmitting unit that transmits the divided media data and the first and second additional information as data for distribution to the receiving terminal device, the additional information generating unit generating one piece of the first additional information and the second information for each the receiving terminal device for one piece of the divided media data, and generating the second additional information using information relating to the receiving terminal device.

According to a further aspect of the present invention, there is provided a data distribution apparatus for distributing media data including at least one of audio data and video data to a communicably connected receiving terminal device, comprising: a managing unit that manages receiving terminal device information that is information relating to the receiving terminal device; a receiving unit that receives media data divided into predetermined units, first additional information that is additional information corresponding such media data, and second additional information for each the receiving terminal device; a generating unit that generates distribution data for a destined receiving terminal device from one of the first or second additional information and the divided media data based on the receiving terminal device information corresponding to the destined receiving terminal device; and a transmitting unit that transmits the distribution data to a corresponding receiving terminal device, wherein the generating unit generates the distribution data from such of the second additional information as corresponds to the destined receiving terminal device and from the divided media data.

According to yet further aspect of the present invention, there is provided a data distribution system in which a data provision apparatus that converts media data including at least one of audio data and video data into data for distribution to a receiving terminal device and outputting the data for distribution and a data distribution apparatus that distributes the media data to a communicably connected receiving terminal device are communicably connected, the data provision apparatus comprising: an acquisition unit that acquires the media data; a dividing unit that divides the media data into predetermined units; a storage unit that stores information relating to the receiving terminal device; an additional information generating unit that generates first and second additional information corresponding to the divided media data; and a transmitting unit that transmits the divided media data and the first and second additional information as data for distribution to the receiving terminal device, the additional information generating unit generating one piece of the first additional information and the second information for each the receiving terminal device for one piece of the divided media data, and generating the second additional information using information relating to the receiving terminal device; the data distribution apparatus comprising: a managing unit that manages receiving terminal device information that is information relating to the receiving terminal device; a receiving unit that receives the media data and the first and the second additional information; a distribution data generating unit that generates distribution data for a destined receiving terminal device from one of the first and second additional information and the divided media data based on the receiving terminal device information corresponding to the destined receiving terminal device; and a transmitting unit that transmits the distribution data to a corresponding receiving terminal device, the distribution data generating unit generating the distribution data from such of the second additional information as corresponds to the destined receiving terminal device and from the divided media data, the receiving unit receiving the divided media data and the distance information from the data provision apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features and aspects of the present invention and, together with the description, serve to explain the principles of the present invention.

FIG. 1 is a block diagram showing a functional configuration example of a data distribution system according to a first embodiment of the present invention;

FIG. 2 is a diagram illustrating the data structure of an MP4 file format containing Fragmented Movie;

FIG. 3 is a flow chart illustrating a process of generating and distributing contents data suited to each of several playback devices 102 in an intermediate server 101 according to the first embodiment of the present invention;

FIG. 4 is a diagram showing an example of playback device connection information used in the embodiment of the present invention;

FIG. 5 is a diagram illustrating a process of rewriting a sequence number and a standard offset carried out at a contents data generator in the first embodiment of the present invention;

FIG. 6 is a diagram showing schematically the flow of data between devices in the first embodiment of the present invention;

FIG. 7 is a diagram illustrating the flow of data between devices in a data distribution system according to a second embodiment of the present invention;

FIG. 8 is a diagram showing schematically data processing from an audio/video data encoding unit 104 to a master data distributor 106 in a network camera 100 in the data distribution system according to the first embodiment of the present invention;

FIG. 9 is a flow chart illustrating processing performed by the contents data generator 108 in the first embodiment of the present invention; and

FIG. 10 is a block diagram showing a functional configuration example of a data distribution system according to the second embodiment of the present invention.

### DESCRIPTION OF THE EMBODIMENTS

Preferred embodiments of the present invention will now be described in detail in accordance with the accompanying drawings.

It should be noted that, although in the embodiments described below, the focus is on instances in which the data used in live video distribution is in MP4 (MPEG4) file format, the present invention can also be applied to live video distribution using other data formats similar to the MP4 format.

The “Motion JPEG 2000 file format” (ISO/IEC 15444-3) and the “AVC file format” (ISO/IEC 14496-15), which have the same basic structure as the MP4 format, have been standardized as such other data formats by the ISO. In addition, there are also moving picture file standards (such as the 3GPP format and the 3GPP2 format) that have been restricted on the premise that they would be used on wireless terminals, chiefly third generation mobile phones. Thus, the present invention can be applied in whole or in part to other standards for which the file format and the architecture adopted are similar to those of the MP4 format.

### First Embodiment

The present exemplary embodiment is an example of the present invention adapted to a data distribution system that distributes contents data to a playback device via an intermediate server from a network camera with a transmission capability.

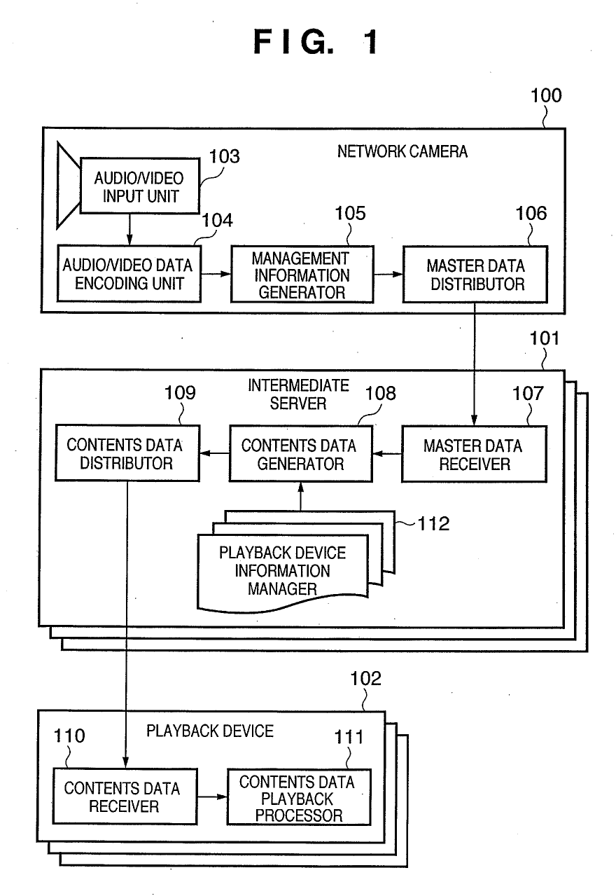

FIG. 1 is a block diagram showing a functional configuration example of a data distribution system according to a first embodiment of the present invention.

The data distribution system of the present embodiment transmits media data in real time and in blocked format. The data distribution system divides media data, which is including at least one of video data and audio data, into predetermined units and adds additional information for constituting data blocks.

The system is comprised of a network camera 100 having a transmission capability, an intermediate server 101 having a capability like that of a so-called proxy server, and a playback device 102 having a contents data playback capability.

The network camera 100 functions as a data provision apparatus that acquires the media data, converts it into a format for data distribution, and outputs it. Specifically, the data provision apparatus is an image capture device, such as a video camera used in monitoring applications and the like in recent years. In addition, the intermediate server 101 that functions as a data distribution apparatus is a proxy server equipped with a communication data cache function, and is generally called a proxy server. The playback device 102 as an example of a receiving terminal device is equipped with a network communication capability, and plays back moving picture images. Although the example shown here uses a receiving terminal that plays back the media data that is received, a playback function is optional.

In some cases, the playback device 102 may be implemented by running an application program on a PC (personal computer). In other cases, the playback device 102 may be implemented as part of a monitoring device equipped with a dedicated display.

At the network camera 100, an audio/video input unit 103 is a so-called video camera, which captures audio and video data and outputs it as digital data. An audio/video data encoding unit 104 divides the captured data into predetermined units (such as at certain time periods) and encodes the data in these units. A management information generator 105 generates management information as additional information corresponding to the encoded audio/video data (coded audio/video data). A master data distributor 106 distributes the coded audio/video data and the additional information (these data together are called master data) to the intermediate server 101.

There may be multiple intermediate servers 101 that are the destinations of the master data from the network camera 100. In the event that there are multiple intermediate servers 101, the network camera 100 distributes the same master data to all the intermediate servers 101.

In the intermediate server 101, a master data receiver 107 receives master data distributed from the network camera 100. A playback device information manager 112 holds and manages connection information for the playback device 102 connected to the intermediate server 101. A contents data generator 108 generates contents data that can be replayed at the playback device 102 from the master data (the coded audio/video data and the management information) that is received and from the connection information for the playback device that is held in the playback device information manager 112. A contents data distributor 109 distributes the contents data generated by the contents data generator 108 to the playback device 102.

As with the intermediate server 101, there may be multiple playback devices 102, and further, that number may change dynamically. However, if there are multiple playback devices 102, a portion of the data may be changed as necessary at the contents data generator 108 depending on the playback device 102, and therefore the same contents data is not necessarily distributed to all the playback devices 102. In addition, the playback device information manager 112 detects any increase or decrease in the number of connected playback devices 102 and constantly holds the latest information for all the playback devices 102.

The playback device 102 is comprised of a contents data receiver 110 that receives contents data from the intermediate server 101 and a contents data playback processor 111 that decodes the coded audio data and video data contained in the contents data and displays it on a display device.

Next, a description will be given of the usual process flow of a system having the structure shown in FIG. 1.

First, as an initial matter, a user who operates the playback device 102 sets the intermediate server 101 as the proxy server, and further, issues a command to acquire coded audio/video data from the network camera 100. Specifically, the user can effect that command by, for example, using a GUI (Graphical User Interface) and inputting the URL (Uniform Resource Locator) of the network camera 100 or the intermediate server 101. Alternatively, the user may define a connection to the playback device 102 in advance and issue a command to start communication using that definition by pressing a switch or the like.

At this time, the information needed to acquire data among the network camera 100, the intermediate server 101 and the playback device 102 is exchanged over a network that connects the devices using HTTP as one example of a data transfer protocol. Then, at the management information generator 105 of the network camera 100, the received command is acknowledged and management information corresponding to the coded audio/video data is generated in a form that conforms to Fragmented. Movie. Then, the master data distributor 106 distributes the coded audio/video data and the corresponding management information to the intermediate server 101 as master data. The master data distributed to the intermediate server 101 is converted to Fragmented Movie data structure at the contents data generator 108 and distributed to the playback device 102.

A description will now be given of the Fragmented Movie data structure using the drawings.

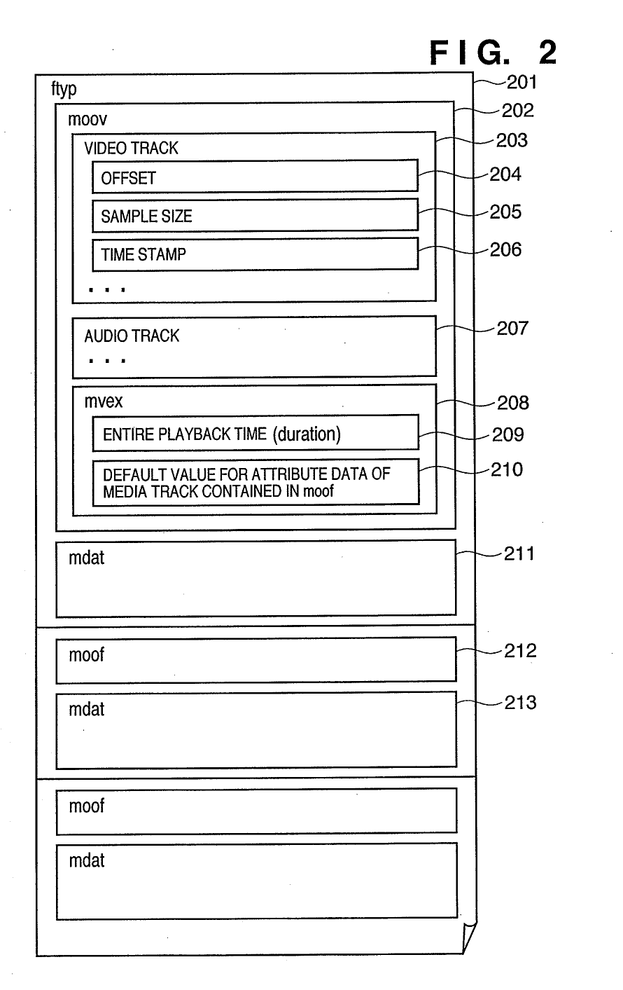

FIG. 2 is a diagram illustrating the data structure of an MP4 file format including Fragmented Movie.

In the MP4 file format, the data that is to be recorded in the file is written into a data structure called a “BOX”, and recorded in the file in BOX units. In addition, in the MP4 file format, the presentation of the contents as a whole is called a “movie”, and the presentation of the media stream that constitutes the contents is called a “track”.

In a first header Movie_BOX (‘moov’) 202, typically, a video track 203 for handling the audio/video data as a whole logically and an audio track 207 for handling audio data as a whole logically are included. In addition, the basic structural content of the video track 203 and the audio track 207 is virtually the same. In other words, both the video track 203 and the audio track 207 record a variety of attribute information pertaining to actual media data, with only the content of that attribute information differing slightly depending on the characteristics of the media data.

The data contained in the video track 203 contains, for example, information on the structure of the decoder and the frame pixel size width and height of the moving picture image for decoding the encoded data. To take a typical example, an offset 204 indicates the position in the file at which the media data is actually recorded. A sample size 205 indicates the size of the frame data (sometimes also called a sample, or, in the case of video data, a picture) of each piece of media data. A time stamp 206 indicates the decode time and the presentation time of each piece of frame data.

The overall structure of an MP4 file 201 is comprised of a header information (metadata) portion, showing the logical position, the chronological position and the characteristics information of the audio and video data, and a media data portion, which is the actual coded audio/video data.

FIG. 2 shows the structure of an MP4 file containing a special Fragmented Movie BOX. In an MP4 file without the Fragmented Movie structure, a “Movie_Extends BOX” (‘mvex’) 208 showing information on the Fragmented Movie extension portion is not included in the “Movie_BOX” (‘moov’) 202. In other words, the MP4 file is comprised only of the ‘moov’ 202 without the ‘mvex’ 208 and a corresponding media data “Media_Data BOX” (‘mdat’) 211.

By contrast, in a Fragmented Movie MP4 file, the contents header information and the media data can be divided into fragments of time units of any length, with the divided fragments recorded in chronological order from the head of the file. At this time, as shown in FIG. 2, the “Movie_Extends_BOX” (‘mvex’) 208 that contains information such as the overall playback time including the fragmented portion (duration) and the like is disposed in the “Movie_BOX” (‘moov’) 202 at the head of the file that contains the attribute information of the contents as a whole. The mvex 208 holds information pertaining to the data that is contained in the “Media_Data_BOX” (‘mdat’) 211 that follows thereafter.

The “Movie_Fragment_BOX” (‘moof’) 212 that appears next is the header information for the fragmented part, and holds data pertaining to the data that is contained in the “Media_Data_BOX” (‘mdat’) 213. Thereafter the same combination (fragment) of “Movie_Fragment_BOX” (‘moof’) 212 and “Media_Data_BOX” (‘mdat’) 213 is added to comprise the structure.

In a Fragmented Movie MP4 file, as described above, a “Movie_Extends_BOX” (‘mvex’) 208 containing Fragmented Movie extension information is present in the “Movie_BOX” (‘moov’) 202. A playback time (duration) 209 for the entire movie including the fragmented portion and information 210 such as default values for sample size of the media data included in the fragmented part and the duration of each sample and the like can be set in the “Movie_Extends_BOX” (‘mvex’) 208. Setting a default value here enables the setting of the values for each sample when using a default value to be eliminated from the sample information in the following “Movie_Fragment_BOX” (‘moof’) 212.

Thus, with Fragmented Movie, a combination of metadata and corresponding media data can be treated as a single block and a plurality of blocks strung together in chronological order to create a file structure. Accordingly, using such a file format, generating a “block of metadata and corresponding media data” at each time unit (or at each certain unit size), and distributing makes it possible to implement live video distribution using an ordinary data transfer protocol. This type of video distribution scheme is hereinafter called fragment distribution.

The management information generated at the management information generator 105 shown in FIG. 1 is the two types of management information (header information) Movie_BOX (‘moov’) 202 and “Movie_Fragment_BOX” (‘moof’) 212 shown in FIG. 2. Normally, in an MP4 file, two types of management information are not needed for the same coded data. However, in the present embodiment, since contents data is generated for a plurality of playback devices 102, two types of management information are generated for the same audio/video coded data encoded at the audio/video data encoding unit 104.

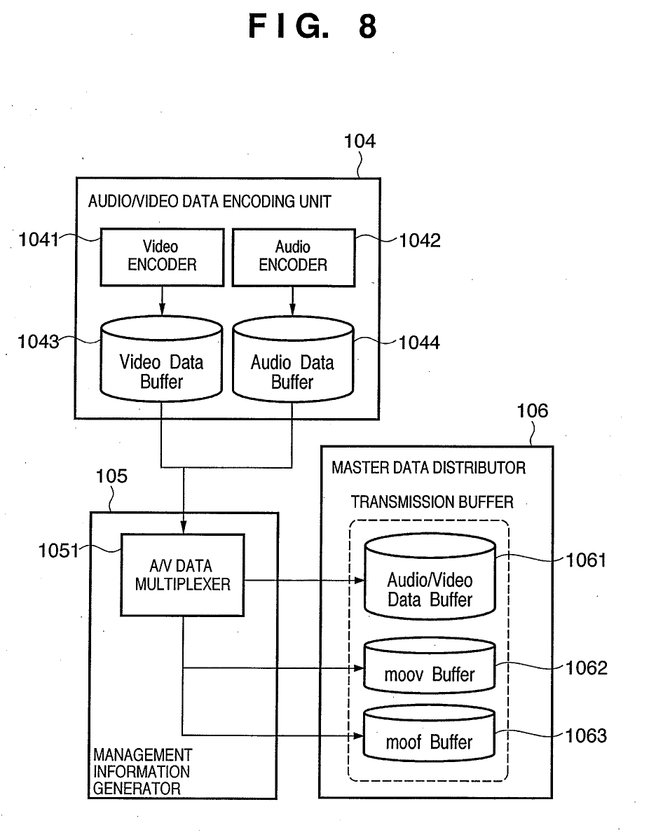

A more detailed description will now be given of the flow of data during live video distribution using FIG. 8.

FIG. 8 is a diagram showing schematically data processing from the audio/video data encoding unit 104 to the master data distributor 106 inside the network camera 100.

In the audio/video data encoding unit 104, the audio/video data that the audio/video input unit 103 outputs is encoded by a video encoder 1041 and an audio encoder 1042. The coded results are stored in a video data buffer 1043 and an audio data buffer 1044. An A/V data multiplexer 1051 of the management information generator 105 generates coded audio/video data interleaving under particular conditions as necessary the coded audio data and the coded video data stored in the buffers. The coded audio/video data is then stored in an audio/video data buffer 1061, which is a transmission buffer inside the master data distributor 106.

In addition, the coded data stored in the transmission buffer audio/video data buffer 1061 corresponds to the “Media_Data_BOX” (‘mdat’) 211 or 213 shown in FIG. 2. The two types of management information Movie BOX (‘moov’) 202 and “Movie_Fragment_BOX” (‘moof’) 212 corresponding to this data are generated inside the management information generator 105, and are then stored in a transmission moov buffer 1062 and a transmission moof buffer 1063, respectively, inside the master data distributor 106.

Then, the master data distributor 106 distributes the data stored in the transmission buffers 1061-1063 as master data. Specifically, the master data that is received at the master data receiver 107 of the intermediate server 101 consists of three types of data, “Media_Data_BOX” (‘mdat’), Movie_BOX (‘moov’) and “Movie_Fragment_BOX” (‘moof’). The master data composed of these three types of data is then distributed jointly to all intermediate servers if there are multiple intermediate servers 101.

Next, the intermediate server 101, which has received the master data, generates contents data for each playback device 102 at the contents data generator 108 from the master data and from the playback device 102 connection information stored in the playback device information manager 112.

A description will now be given of an arrangement for managing information for a plurality of playback devices 102 in fragment distribution, and a method of generating contents data suitable for each playback device 102.

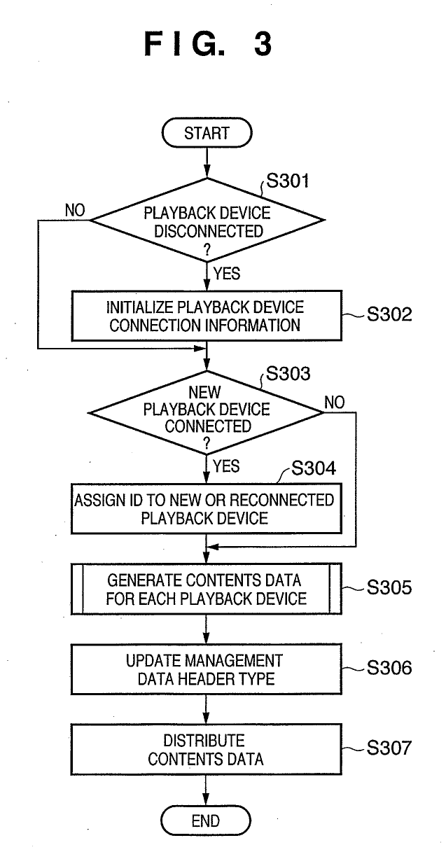

FIG. 3 is a flow chart illustrating a process of managing information for the plurality of playback devices 102 and of generating and distributing contents data suited to each playback device 102 in the intermediate server 101.

First, unique IDs are assigned to each of a plurality of playback devices 102 already connected to one particular intermediate server 101 in order to manage the connection status at each playback device. Then, in an initial step S301, it is determined whether or not an already connected playback device has been disconnected, by removal of the device, switching OFF of power or the like. If a playback device has been removed, in step S302 the corresponding ID data is initialized so that it can be reused.

Next, in step S303, it is determined whether or not there is a playback device 102 connection request. If there is a connection request, then in step S304 an ID for identifying control data for a new or a reconnected playback device 102 is assigned and status control at each playback device 102 is enabled.

Next, in step S305, the connection at each playback device 102 is checked and contents data for individual playback devices 102 is generated. In step S306, the header type held as playback device information control is updated. These processes are carried out inside the contents data generator 108, with detailed descriptions of the process contents given later.

Next, in step S307, the generated contents data is distributed to the playback devices 102.

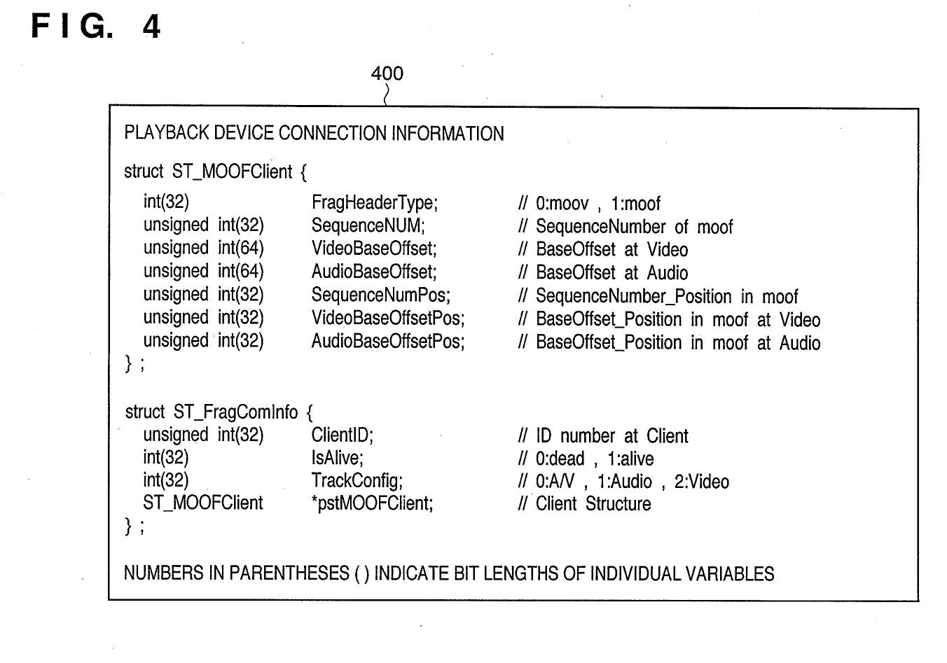

Playback device connection information like that shown for example in FIG. 4 for holding and managing connection information for connected playback devices 102 is stored in the intermediate server 101. Playback device connection information 400 shown in FIG. 4 is an example of the data structure for managing the connection status of the playback device 102, and is held and managed in the playback device information manager 112.

“ST_MOOFClient” is a data structure for managing the status of each playback device 102, in which the meanings of the member variables are as described below.

“FragHeaderType” shows the type of management information that is to be added to the contents data with the current distribution, and is used to identify either Movie_BOX (‘moov’) 202 or “Movie_Fragment_BOX” (‘moof’) 212. 0 means ‘moov’ and 1 means ‘moof’. For a given playback device 102, Movie_BOX (‘moov’) is added to the contents data distributed first, after which “Movie_Fragment_BOX” (‘moof’) is added.

“SequenceNUM” shows a number that should appear at a predetermined position inside the “Movie_Fragment_BOX” when adding “Movie_Fragment_BOX” (‘moof’) 212 management information and generating contents data. This number starts from 1 when generating and distributing contents data to which “Movie_Fragment_BOX” management information has been added at the beginning, and is incremented with each contents data generation/distribution thereafter.

“VideoBaseOffset” and “AudioBaseOffset”, like the above-described “SequenceNUM”, show standard offset values that should appear inside the “Movie_Fragment_BOX”, and must be set to values appropriate for video track and audio track.

The next three member variables, “SequenceNUMPos”, “VideoBaseOffsetPos” and “AudioBaseOffsetPos”, represent recording position information for member variables “SequenceNUM”, “VideoBaseOffset” and “AudioBaseOffset”, respectively. In other words, the values shown by the member variables “SequenceNUMPos”, “VideoBaseOffsetPos” and “AudioBaseOffsetPos” are information showing where values indicated by the member variables “SequenceNUM”, “VideoBaseOffset” to be recoded in “Movie_Fragment_BOX” (‘moof’) 212, respectively.

Specifically, for example, the recording position information shows an offset position from the head of the “Movie_Fragment_BOX” (‘moof’) 212. Then, the playback device information manager 112 rewrites the respective data at the positions shown by the member variables “SequenceNUMPos”, “VideoBaseOffsetPos” and “AudioBaseOffsetPos” inside the “Movie_Fragment_BOX” (‘moof’) 212 and generate contents data for fragment distribution suited to each playback devices 102.

One more data structure that comprises the playback device connection information, “ST_FragComInfo”, has four member variables.

“Client ID” is a unique ID assigned to each playback device 102.

“IsAlive” indicates the connection status of the playback device identified by the “Client ID” (that is, whether connected or not). 0 means disconnected and 1 means connected.

“TrackConfig” shows the track configuration (for example, whether there is an audio/video track to be received). 0 means that both tracks are present, 1 means only an audio track, and 2 means only a video track.

“ST_MOOFClient” holds the address at the head of the corresponding data structure “ST_MOOFClient”.

Thus, as described above, the status of each of the playback devices 102 can be held and managed by the data structure “ST_FragComInfo”.

A description of processing relating to the “FragHeaderType” in the process flow shown in FIG. 3 will now be supplemented.

In Fragmented Movie, the ‘moov’ format header is added only to the head of the file as described above (the data that is distributed first to each of the playback devices 102), after which management information is held by the ‘moof’ format header. Then, in the initialization of the management information in step S302 shown in FIG. 3, a constant is set (in this embodiment 0) that shows that the “FragHeaderType” that corresponds to an ID that is not being used is Movie_BOX (‘moov’). Then, in the updating of the header type of the control data in step S306, if a constant (0) showing Movie_BOX (‘moov’) is set in the “FragHeaderType”, this is changed to a constant showing “Movie_Fragment_BOX” (‘moof’) (in this embodiment 1), which makes it possible to generate contents data to which management information in the correct format as Fragmented Movie is added.

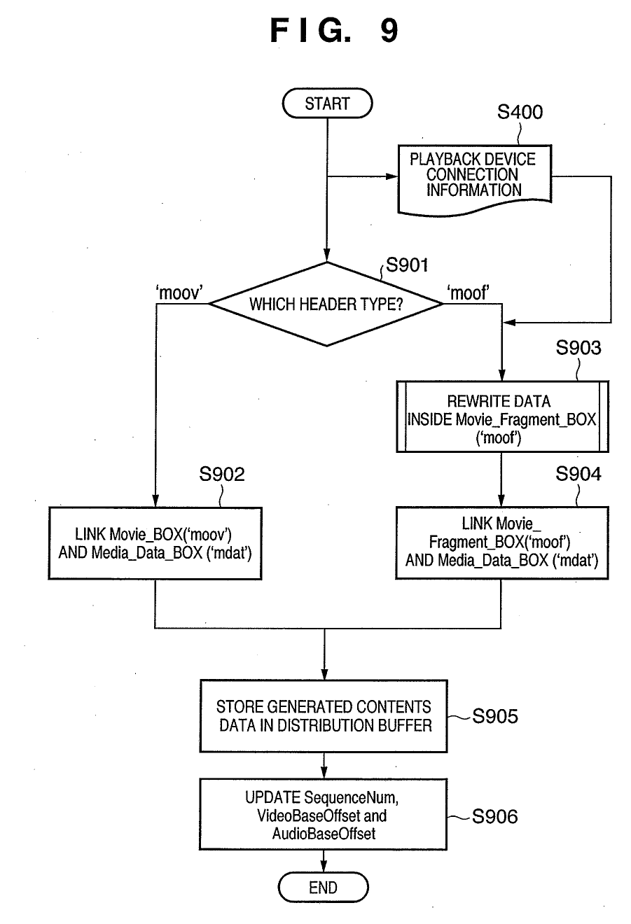

In addition, the generation of contents data is processed by the contents data generator 108 in the intermediate server 101. Hereinafter, a description will be given of steps in a process of generating contents data for fragment distribution at the contents data generator 108 from the master data and from the playback device connection information 400, with reference to the flow chart shown in FIG. 9.

Once the contents data generation process is started, first, in step S901, the value of the “FragHeadertype” of the playback device connection information 400 is checked and the header type identified (as either ‘moov’ or ‘moof’).

If the header type is ‘moov’, in step S902 data that strings together Movie_BOX (‘moov’) and “Media_Data_BOX” (‘mdat’), which is divided media data, is generated as data for distribution. On the other hand, if the header type is ‘moof’, then, first, in step S903, the playback device connection information 400 is checked and the data contained in the “Movie_Fragment_BOX” (‘moof’) is rewritten. Then, in step S904, data that strings together the partially rewritten “Movie_Fragment_BOX” (‘moof’) and “Media_Data_BOX”, which is divided media data, is generated.

Next, in step S905, the data strung together in step S902 or in step S904 is stored in the contents data distribution buffer as contents data for fragment distribution.

Finally, in step S906, the playback device connection information 400 is updated. Specifically, the “SequenceNUM” is incremented by 1 and the values of the “VideoBaseOffset” and the “AudioBaseOffset” are updated on the basis of the size of the generated data.

This series of processes is repeated as many times as there are connected playback devices 102, in other words, as many times as there are playback device connection information 400 “ClientID”s assigned to each playback device 102. In this manner, contents data corresponding to each of the playback devices 102 under management by the intermediate server 101 is generated.

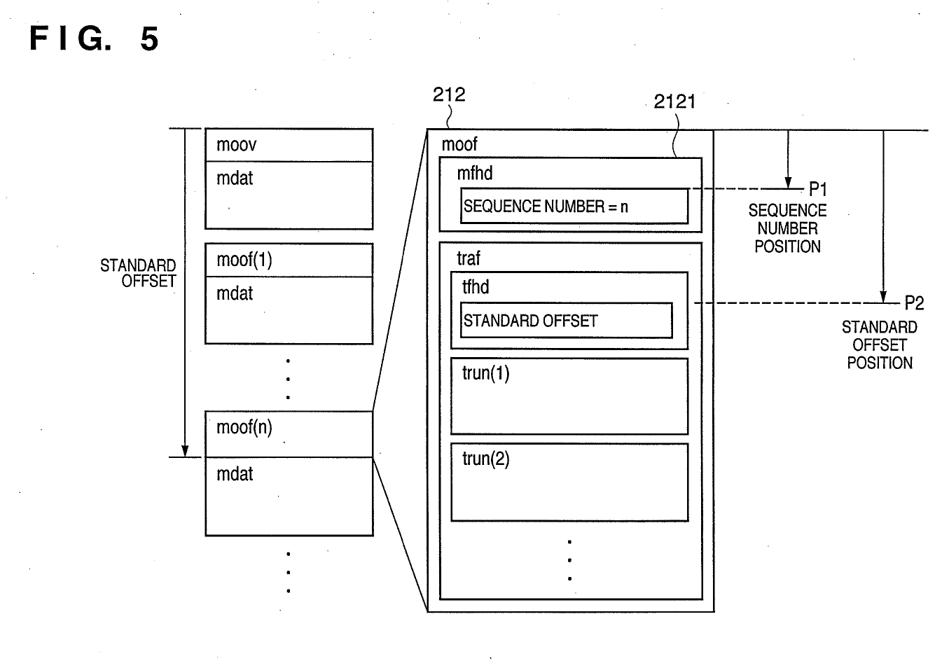

A detailed description will now be given of the rewriting of the data inside the “Movie_Fragment_BOX” (‘moof’) 212 in step S903 described above, in other words, the rewriting of the “SequenceNUM”, “VideoBaseOffset” and “AudioBaseOffset”, using FIG. 4 and FIG. 5.

FIG. 5 is a diagram illustrating a process of rewriting three types of parameters, the sequence number and the standard offsets (video and audio), that should be recorded at predetermined positions inside the “Movie_Fragment_BOX” (‘moof’) 212 in the present embodiment.

The sequence number must set an appropriate value at a predetermined position P1 inside a “Movie_Fragment_Header_BOX” (‘mfhd’) 2121 inside the “Movie_Fragment_BOX” (‘moof’) 212. Then, the rewrite position is controlled by the member variable “SequenceNUMPos” in the playback device connection information, and the rewrite value is controlled by the “SequenceNUM” in the playback device connection information, for each “ClientID” (that is, for each playback device). Specifically, the member variable “SequenceNUMPos” corresponds to the sequence number position shown in FIG. 5, and the “SequenceNuM” corresponds to the sequence number.

The “sequence NUM”, as described above, has an initial value of 1 and is incremented by 1 each time, but the rewrite position “SequenceNUMPos”, because it is the position from the head of the moof, normally becomes a fixed value in a case in which the same processing sequence is repeated. However, when for some reason the “SequenceNUMPos” is changed, it is preferable that this value be provided from the network camera 100 that generates the master data.

The standard offset, like the sequence number, rewrites the data of a position P2 specified by the “VideoBaseOffsetPos” and the “AudioBaseOffsetPos” inside the “Movie_Fragment_BOX” (‘moof’) 212 to the values of the “VideoBaseOffset” and the “AudioBaseOffset”. It should be noted that although in FIG. 5 no distinction is made between audio and video, in reality the audio and the video are rewritten separately. The “VideoBaseOffsetPos” and the “AudioBaseOffsetPos” are values that indicate the standard offset position P2, respectively, and the “VideoBaseOffset” and the “AudioBaseOffset” values are the equivalents of the standard offset that is to be written in.

The value of the standard offset is the sum of the size of the “Movie_Fragment_BOX” (‘moof’) 212 to be distributed currently added to the total (the number of bytes) of data distributed up to that point to that playback device.

The two types of standard offset positions, “VideoBaseOffsetPos” and “AudioBaseOffsetPos”, like “SequenceNUMPos”, are normally fixed values as long as the same processing sequence is repeated. However, if for some reason (such as dynamic change in the frame rate or bit rate) the rewrite position is changed, it is preferable that these values be provided from the network camera 100 that generates the master data.

With this scheme, contents data that is rewritten as data suitable for each playback device 102 and generated by the contents data generator 108 in the intermediate server 101 is distributed to each of the playback devices 102 by the contents data distributor 109. This contents data is received at the contents data receiver 110 in each playback device 102 and playback carried out at the contents data playback processor 111.

If the contents data that is received is strung together, it is the same as Fragmented Movie data. Therefore, it is the same as the playback device 102 dividing the Fragmented Movie data, downloading it and playing it back, insofar as ultimately it is replayed as a continuous single piece of video data.

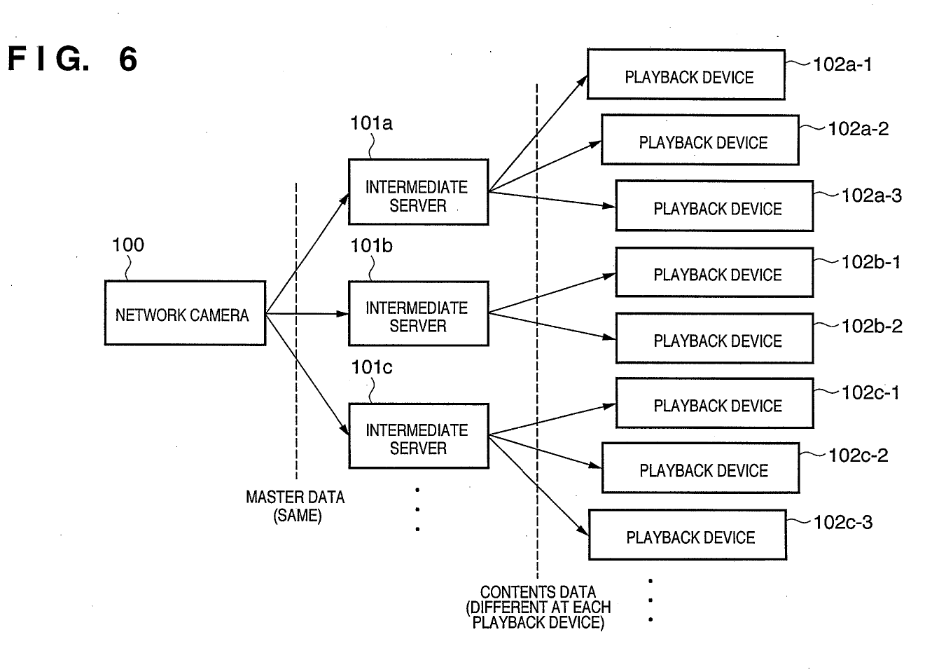

FIG. 6 is a diagram showing schematically the flow of data between devices in the present embodiment.

In FIG. 6, the data that is distributed from the network camera 100 to three intermediate servers 101a-101c is master data combining two types of data, audio/video data and management information, and the same master data is distributed to all the intermediate servers. At the same time, the data that is distributed from intermediate server 101a to playback devices 102a-1 to 102a-3 is contents data that has been partially revised based on the connection information for each of the playback devices. Similarly, the data distributed from intermediate server 101b to playback devices 102b-1 to 102b-3, and from intermediate server 101c to playback devices 102c-1 to 102c-3, also varies with each playback device.

According to the present embodiment, the intermediate server 101 carries out generation of data suited to each of the playback devices. As a result, the network camera 100 can distribute the same master data to all the intermediate servers 101 without regard to any increase or decrease in the number of playback devices 102.

As a result, compared to a case in which the network camera 100 generates data for each playback device, the processing load on the network camera 100 is greatly reduced. In addition, the network traffic between the network camera 100 and the intermediate server 101, depending as it does only on the number of intermediate servers 101, also is greatly reduced.

Put differently, in the present embodiment, the network camera 100 disperses the data processing load of generating contents data for each of the playback devices among the intermediate servers 101a-101c.

### Second Embodiment

Next, as a second embodiment of the present invention, a description will be given of the installation of the functions of the intermediate server 101 in the network camera 100 of the first embodiment.

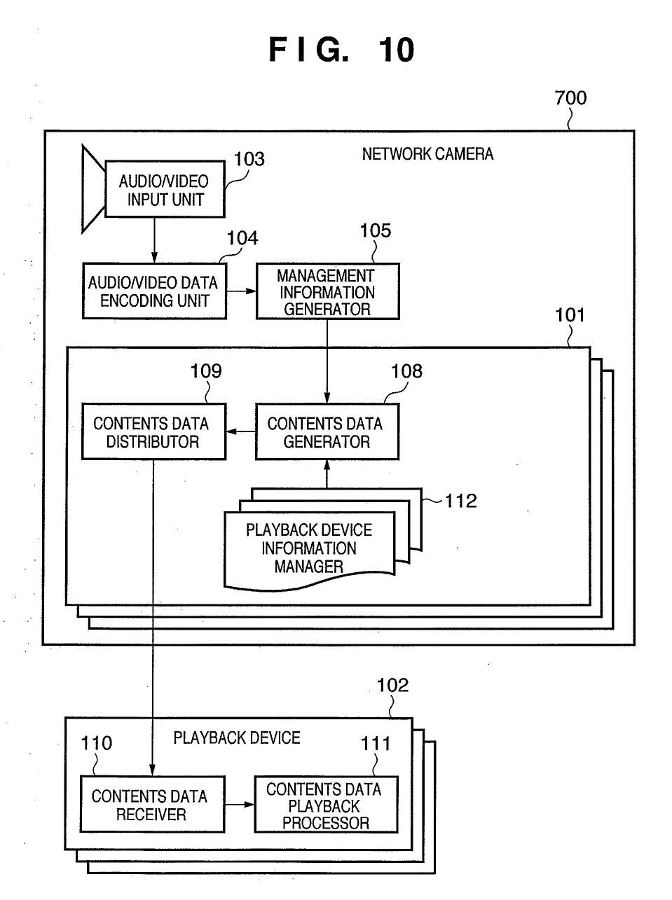

FIG. 10 is a block diagram showing a functional configuration example of a data distribution system according to the second embodiment of the present invention, in which structures identical to those shown in FIG. 1 are given identical reference numerals. As is clear from a comparison of FIG. 1 and FIG. 10, in the present embodiment, the network camera 700 has the capabilities of both the network camera 100 and the intermediate server 101 of the first embodiment.

The coded audio/video data and the management information provided by the management information generator 105 are input directly to the contents data generators 108 of the intermediate servers 101.

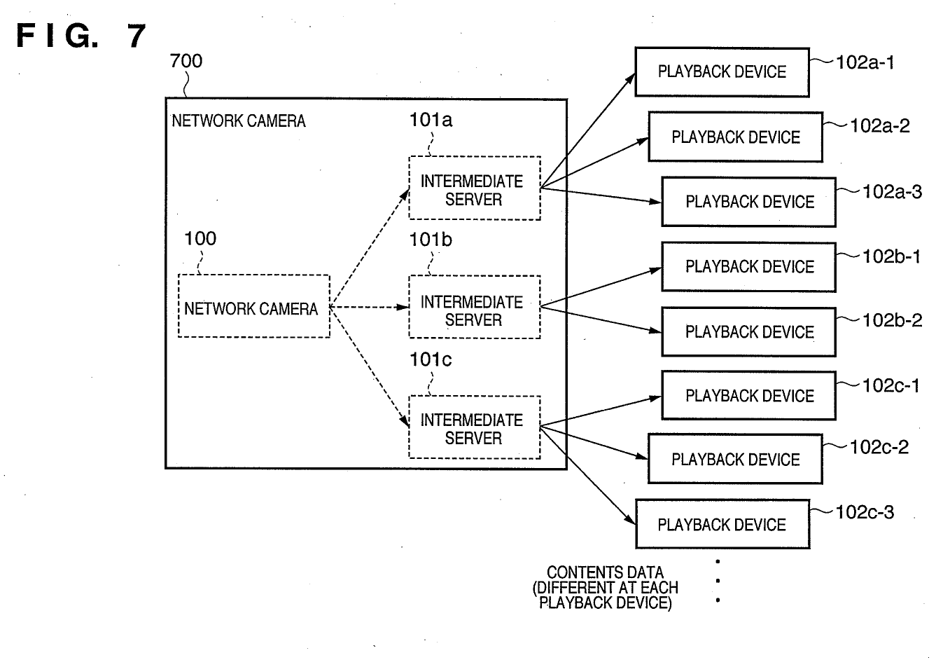

FIG. 7 is a diagram illustrating the flow of data between devices in a data distribution system according to the second embodiment. As shown in FIG. 7, in this embodiment, the status management of a plurality of playback devices 102 is carried out directly inside the network camera 700, which generates and distributes contents data suited to each of the playback devices 102 from the information concerning status management and from the master data.

In the present embodiment as well, by providing multiple structures equivalent to the intermediate server 101 in the network camera 700, the internal processing load can be dispersed. In addition, in this case, there may be one or more than one of that or those which is or are the equivalent of the intermediate server 101, and their number may be varied adaptively according to the number of connected playback devices, increase or decrease in data traffic in the internal bus, and so forth.

### Third Embodiment

In the first embodiment of the present invention, the process of revising the “Movie_Fragment_BOX” (‘moof’) 212 of the management information in the master data to contents suited to individual playback devices 102 is carried out by a contents data generator inside the intermediate server 101. In the present embodiment, this process is carried out inside the network camera. In other words, in this embodiment, the network camera also functions as a data distribution apparatus.

The functional structure of the data distribution system according to the present embodiment is the same as that of the first embodiment, and may be the configuration shown in FIG. 1. However, the content of the processes performed and the data handled by the management information generator 105 and the master data distributor 106 inside the network camera 100, as well as by the master data receiver 107 and the contents data generator 108 inside the intermediate server 101, are slightly different.

Specifically, in the third embodiment, the process of generating data in which the content of the “Movie_Fragment_BOX” (‘moof’) 212 is revised to suit individual playback devices 102 based on the playback device connection information 400 that manages the status of the playback devices 102 is carried out by the management information generator 105.

Therefore, when multiple playback devices 102 are connected, the master data distributed from the master data distributor 106 to the intermediate server 101 is as follows: “Media_Data_BOX” (‘mdat’), Movie_BOX (‘moov’) and multiple “Movie_Fragment_BOX” (‘moof’) having contents suited to each playback device 102. In other words, whereas in the first embodiment the management information generator 105 generates one type of ‘moof’, in this embodiment the management information generator 105 generates ‘moof’ having contents suited to each of the playback devices 102.

At the intermediate server 101, this data is received at the master data receiver 107. Then, by combining the ‘moov’ or the ‘moof’ and the ‘mdat’ as appropriate at the contents data generator 108 based on the ‘moof’ contained in the master data and on the playback device connection information 400, contents data that accommodates each playback device 102 is generated.

In other words, the major difference with the first embodiment is that the process of generating “Movie_Fragment_BOX” (‘moof’) suited to each playback device 102 is carried out on the network camera 100 end. Then, at the intermediate server 101 end, the master data internal (‘moof’) is not revised at all, and contents data suited to each playback device 102 can be generated by combining as appropriate either Movie_BOX (‘moov’) or “Movie_Fragment_BOX” (‘moof’) with “Media_Data_BOX” (‘mdat’).

Creating ‘moof’ suited to the playback device 102 at the network camera 100 requires the information of the playback device connection information 400 at the network camera 100 as well. As a result, the network camera 100 must be able to utilize the playback device connection information 400 that is held and managed at the playback device information manager 112 inside the intermediate server 101.

It is not efficient for the network camera 100 to access the intermediate server 101 constantly and checking or acquiring the playback device connection information 400 when generating management information. Accordingly, for example, the network camera 100 acquires the playback device connection information 400 from the connected intermediate server 101 at predetermined intervals and stores it in a storage device, not shown, inside the network camera 100. In addition, it is preferable that the network camera 100 update the playback device connection information 400 at those predetermined intervals, and eliminate the burden of creating moof for disconnected playback devices 102.

It should be noted that the intermediate server 101 directly manages the connection status of the playback device 102, and therefore, if there is a change in the connection status, or if there is a change in the playback device connection information 400 held by the intermediate server 101, matters may be configured so that the network camera 100 is notified of such a change by the intermediate server 101. The network camera 100, having received notice, then acquires the latest playback device connection information 400 and updates the playback device connection information 400 in the camera. Of course, the latest playback device connection information 400 may be transmitted from the intermediate server 101 to the network camera 100.

Thus, as described above, the network camera 100 of the present embodiment generates management information (‘moov’, and ‘moof’ for each playback device) on the basis of playback device connection information 400 that it holds itself, and distributes it together with coded audio/video data (‘mdat’) as master data.

The contents data generator 108 of the intermediate server 101 checks the information that is unique to each playback device contained in the “Movie_Fragment_BOX” (‘moof’) for each playback device 102 that is included in the master data, compares it with the information contained in the playback device connection information 400 that it holds itself, and identifies that contents data to be distributed to which playback device for which it is the ‘moof’_that should be used.

As information unique to the playback device contained in the ‘moof’, and moreover contained in the playback device connection information 400, there is, for example, at least either the standard offset or the sequence number, and preferably both. Based on this information, the appropriate ‘moof’ is identified and the appropriate contents data for the playback devices 102 is generated. It should be noted that if the header type is moov no identification process is necessary.

In the third embodiment described above, the content of the master data that is distributed from the network camera 100 to the intermediate server 101 is as follows:

“Media_Data_BOX” (‘mdat’) −− 1
“Movie_BOX” (‘moov’) data −− 1
“Movie_Fragment_BOX” (‘moof’) data −− at a

maximum, the number of playback devices 102.

In addition, it is also necessary to acquire information relating to each individual playback device from the intermediate server.

As a result, compared to the first embodiment, the trouble of generating the “Movie_Fragment_BOX” (‘moof’) in particular, and the traffic with the intermediate server 101, increases. However, there is no need to revise the contents of the master data at the intermediate server 101, and thus the processing load on the intermediate server 101 is reduced.

In any case, compared to the conventional data distribution system, in which the network camera 100 generates contents data for each playback device, both the processing load and the network traffic can be reduced.

### Other Embodiments

Although the first through third embodiments described above describe a scheme that uses fragment distribution to carry out live video distribution using Fragmented Movie in ISO Base Media File Format, the present invention is applicable to any case in which, in live video distribution using a file transfer protocol such as HTTP, the only difference in the contents data that is distributed to a plurality of playback devices is the information in the header portion.

In addition, although the above-described embodiments describe the distribution of both audio and video data, the present invention is also applicable to a system in which only one of these types of data is distributed.

An instance in which the same functions as those described above are achieved by the computer of a system or an apparatus including a computer executing a computer program that implements the functions of the embodiments described above is also within the scope of the present invention. The program may be supplied to the system including a computer or to the computer either directly from the recording medium or by using wire/wireless communication.

Accordingly, since a computer implements the functional processes of the present invention, a program supplied to and installed in the computer itself also accomplishes the present invention. In other words, the computer program for implementing the functional processes of the invention is itself also included within the scope of the present invention.

In that case, so long as the system or apparatus has the capabilities of the program, the program may be executed in any form, such as an object code, a program executed by an interpreter, or script data supplied to an OS.

Examples of storage media that can be used for supplying the program are magnetic storage media such as a floppy disk, a hard disk, or magnetic tape, optical/magneto-optical storage media such as an MO, a CD-ROM, a CD-R, a CD-RW, a DVD-ROM, a DVD-R, or a DVD-RW, and a non-volatile semiconductor memory or the like.

As for the method of supplying the program using wire/wireless communications, there is, for example, a method in which a data file (program data file), either a computer program itself that forms the invention or a file or the like that is compressed and automatically installed, and capable of becoming the computer program that comprises the invention on a client computer, is stored on a server on a computer network. The program data file may be in an executable format, or it may be in the form of source code.

Then, the program data file is supplied by downloading to a connected client computer accessing the server. In this case, the program data file may also be divided into a plurality of segment files and the segment files distributed among different servers.

In other words, a server device that provides program data files for implementing the functional processes of the present invention by computer to one or more client computers is also covered by the claims of the present invention.

It is also possible to encrypt and store the program of the present invention on a storage medium, distribute the storage medium to users, allow users who meet certain requirements to download decryption key data from a website via the Internet, and allow these users to decrypt the encrypted program by using the key data, whereby the program is installed in the user computer.

Besides cases where the aforementioned functions according to the embodiments are implemented by executing the read program by computer, an operating system or the like running on the computer may perform all or a part of the actual processing, so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or part of the actual processing so that the functions of the foregoing embodiment can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-365423, filed on Dec. 19, 2005, which is hereby incorporated by reference herein in its entirety.

What is claimed is:

1. A data distribution apparatus for distributing media data including at least one of audio data and video data to a communicably connected receiving terminal device, comprising:
a managing unit that manages receiving terminal device information that is information relating to said receiving terminal device;
a receiving unit that receives media data divided into predetermined units and first and second additional information corresponding to such media data;
a generating unit that generates distribution data for each destined receiving terminal device from one of said first and second additional information and said divided media data based on said receiving terminal device information corresponding to said destined receiving terminal device; and
a transmitting unit that transmits said distribution data to a corresponding receiving terminal device,
wherein said generating unit changes said second additional information based on said receiving terminal device information corresponding to said destined receiving terminal device and generates said distribution data from such changed second additional information and from corresponding said media data.

2. The data distribution apparatus according to claim 1, wherein said generating unit generates said distribution data using said first additional information when generating distribution data to be transmitted first to said destined receiving terminal device and thereafter using said second additional information.

3. The data distribution apparatus according to claim 1, wherein said second additional information after said change differs with each said receiving terminal in a case in which there is a plurality of said receiving terminal devices.

4. The data distribution apparatus according to claim 1, wherein said first and second additional information are different types of header information.

5. The data distribution apparatus according to claim 1, further comprising:
an acquisition unit that acquires said media data;
a dividing unit that divides said media data into said predetermined units; and
an additional information generating unit that generates said first and second additional information corresponding to said divided media data,
wherein said receiving unit receives said divided media data and said first and second additional information from said additional information generating unit.

6. A data provision apparatus that converts media data including at least one of audio data and video data into data for distribution to a receiving terminal device and outputting said data for distribution, comprising:
an acquisition unit that acquires said media data;
a dividing unit that divides said media data into predetermined units;
a storage unit that stores information relating to said receiving terminal device;
an additional information generating unit that generates first and second additional information corresponding to said divided media data; and
a transmitting unit that transmits said divided media data and said first and second additional information as data for distribution to said receiving terminal device,
said additional information generating unit generating one piece of said first additional information and said second information for each said receiving terminal device for one piece of said divided media data, and generating said second additional information using information relating to said receiving terminal device.

7. A data distribution apparatus for distributing media data including at least one of audio data and video data to a communicably connected receiving terminal device, comprising:
a managing unit that manages receiving terminal device information that is information relating to said receiving terminal device;
a receiving unit that receives media data divided into predetermined units, first additional information that is additional information corresponding such media data, and second additional information for each said receiving terminal device;
a generating unit that generates distribution data for a destined receiving terminal device from one of said first or second additional information and said divided media data based on said receiving terminal device information corresponding to said destined receiving terminal device; and
a transmitting unit that transmits said distribution data to a corresponding receiving terminal device,
wherein said generating unit generates said distribution data from such of said second additional information as corresponds to said destined receiving terminal device and from said divided media data.

8. A data distribution system in which a data provision apparatus that converts media data including at least one of audio data and video data into data for distribution to a receiving terminal device and outputting said data for distribution and a data distribution apparatus that distributes said media data to a communicably connected receiving terminal device are communicably connected,
said data provision apparatus comprising:
an acquisition unit that acquires said media data;
a dividing unit that divides said media data into predetermined units;
a storage unit that stores information relating to said receiving terminal device;
an additional information generating unit that generates first and second additional information corresponding to said divided media data; and
a transmitting unit that transmits said divided media data and said first and second additional information as data for distribution to said receiving terminal device,
said additional information generating unit generating one piece of said first additional information and said second information for each said receiving terminal device for one piece of said divided media data, and generating said second additional information using information relating to said receiving terminal device;
said data distribution apparatus comprising:
a managing unit that manages receiving terminal device information that is information relating to said receiving terminal device;
a receiving unit that receives said media data and said first and said second additional information;
a distribution data generating unit that generates distribution data for a destined receiving terminal device from one of said first and second additional information and said divided media data based on said receiving terminal device information corresponding to said destined receiving terminal device; and
a transmitting unit that transmits said distribution data to a corresponding receiving terminal device,
said distribution data generating unit generating said distribution data from such of said second additional information as corresponds to said destined receiving terminal device and from said divided media data,
said receiving unit receiving said divided media data and said distance information from said data provision apparatus.

9. A computer-readable storage medium storing a program for causing a computer to function as the data distribution apparatus according to claim 1.

10. A computer-readable storage medium storing a program for causing a computer function as the data distribution apparatus to according to claim 7.
